(19) United States
(12) Patent Application Publication
(10) Pub. No.: US 2004/0177540 A1
(43) Pub. Date: Sep. 16, 2004

(54) Image assembly and method of using the same to produce backlit enhanced display

(76) Inventor: Elijah Abron, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/753,815

(22) Filed: Jan. 7, 2004

Related U.S. Application Data
(60) Provisional application No. 60/438,373, filed on Jan. 7, 2003.

(51) Int. Cl. G09F 13/04

(52) U.S. Cl. 40/577

(57) ABSTRACT

An image assembly for backlit display includes a display image on a display medium and a masking image disposed at a back side of the display image and adjacent thereto. The masking image has a pattern of light transmittance which is at least partially determined as a function of the pattern of light density of the display image. The pattern of light transmittance of the masking image and the pattern of the light density of the display image are spatially correlated such that the display image has an improved backlit appearance.

### CROSS-REFERENCE TO RELATED APPLICATION(S)

This application claims the priority date of U.S. provisional patent application No. 60/438,373 filed on Jan. 7, 2003 and entitled “METHOD OF BLOCKING A LIGHT WITH A PHOTO FILM TO PRODUCE BACKLIT DISPLAY”.

### BACKGROUND OF THE INVENTION

The present invention relates to a method for backlighting a display, and more specifically relates to a system and method for modifying light distribution to enhance visual effect of a backlit display or a light box.

Backlit displays or light boxes have been widely used to enhance various displayable materials such as pictures, prints, posters, graphics, photography and other artwork. A typical backlit display device projects light from an enclosed light source through a graphic display media towards the viewer, thereby enhancing the visual effect, especially in light situations such as evening hours or indoor areas. Examples of backlit displays or light boxes are found in U.S. Pat. Nos. 1,320,537, 1,911,962, 2,487,403, 2,297,851, 4,418,378, 4,587,754, 4,794,492, 4,831,755, 4,835,661, 4,851,971, 4,942,685, 4,989,122, 5,943,801, 6,557,284 and 6,572,011.

Common problems for backlit display devices include uneven distribution of light, low contrast of the display, and undesirable shadows, all contributing to low quality of viewing experience. Various methods have been proposed to improve the quality of backlit systems. U.S. Pat. No. 4,835,661, for example, discloses an enhanced lighting unit useful for lighting displayable materials. The lighting unit in that patent uses a light diffusing surface in the unit housing placed opposite to, and substantially coextensive with, the planar display area, to improve the uniformity of the light distribution on the display. Other designs that use diffusers, panels and reflectors to improve the quality of backlit system are also found in, for example, U.S. Pat. No. 4,989,122 and U.S. Pat. No. 4,794,492.

The existing backlit systems, however, are either unsatisfactory in performance or too expensive and too complex, preventing backlit displays from being successfully incorporated into the total low light level visual experience. This condition is especially pronounced in low light environments. It remains desirable to develop a backlit system to further improve the display quality and at the same time suitable for various applications including commercial settings and residential settings.

### BRIEF SUMMARY OF THE INVENTION

The present invention is a method and an apparatus for enhancing backlit image display. The method utilizes an image assembly for backlit display. The image assembly includes a display image on a display medium and a masking image disposed at a back side of the display image and adjacent thereto. The masking image has a pattern of light transmittance which is at least partially determined as a function of the pattern of light density of the display image. The pattern of light transmittance of the masking image and the pattern of the light density of the display image are spatially correlated such that the display image has an improved backlit appearance.

In one embodiment, the image assembly is a laminate including a display image layer and a light masking layer. The display image is made on the display image layer, and the masking image is made on the light masking layer, the two layers being coextensively laminated together. The light masking layer can be a photo film bearing a positive copy of the display image, and thus can be fabricated using a photography process.

The image assembly in accordance with the present invention can be used in a variety of backlit applications such as backlit advertisement displays, backlit light boxes and backlit framed pictures.

The present invention takes advantage of a novel arrangement that creates a spatial correspondence between the pattern of light transmittance of the light masking layer and the pattern of light density of the display image layer to modulate the backlit effect. The modulation has high specificity with respect to the particular display image. For example, when the masking image is at least an approximate positive copy of the display image, the pattern of light density of the display image is effectively enhanced and the contrast of the display image is thus improved.

### BRIEF DESCRIPTION OF THE DRAWINGS

The present invention will be further explained with reference to the drawing figures listed below, wherein like structure is referred to by like numerals throughout the several views.

FIG. 1 is an exploded schematic view of an image assembly in accordance with the present invention.

FIG. 2 shows the image assembly in a laminated form.

FIG. 3 shows an exploded schematic view of a backlit display unit using the image assembly in accordance with the present invention.

### DETAILED DESCRIPTION

In the present description, the term “backlit display” refers to a device at least partially projects light from a light source through a graphic display media towards the viewer. A typical backlit display uses backlighting to enhance the visual effect, rather than exclusively illuminate a display image. An actual visual experience of a typical backlit display is therefore a combination of both front-lit (reflective) visual effect and backlit (transparent or translucent) visual effect. The present invention further improves the backlit visual enhancement of the backlit display.

The various designs of backlit systems found in the prior art, such as that in the references cited in the present invention, address the existing problems to various degrees of success. The inventor of the present invention discovered that, in addition to using the existing methods such as reflectors, light screens and diffusers, the viewing quality of a backlit display can be improved by fundamentally modulate the light distribution that reaches a backlit display image. In a general sense, the prior art designs using the reflectors, light screens and diffusers all draw to a scheme of some kind for distributing or redistributing the light from the backlit light source. However, such a scheme is based on the characteristics of the light traveling path in the backlit display unit and does not consider the characteristics of the display image itself. The present invention uses a masking image created based on the characteristics of the display image and takes advantage of a novel arrangement between the masking image and the display image to modulate the backlit effect. This is done by creating a spatial correspondence between the pattern of light transmittance of the light masking image and the pattern of light density of the display image. In a particularly advantageous arrangement, the masking image is at least an approximate positive copy of the display image. The overlapping of the masking image and the display image effectively enhances the pattern of the light density of the display image and thus improves the contrast of the backlit display image.

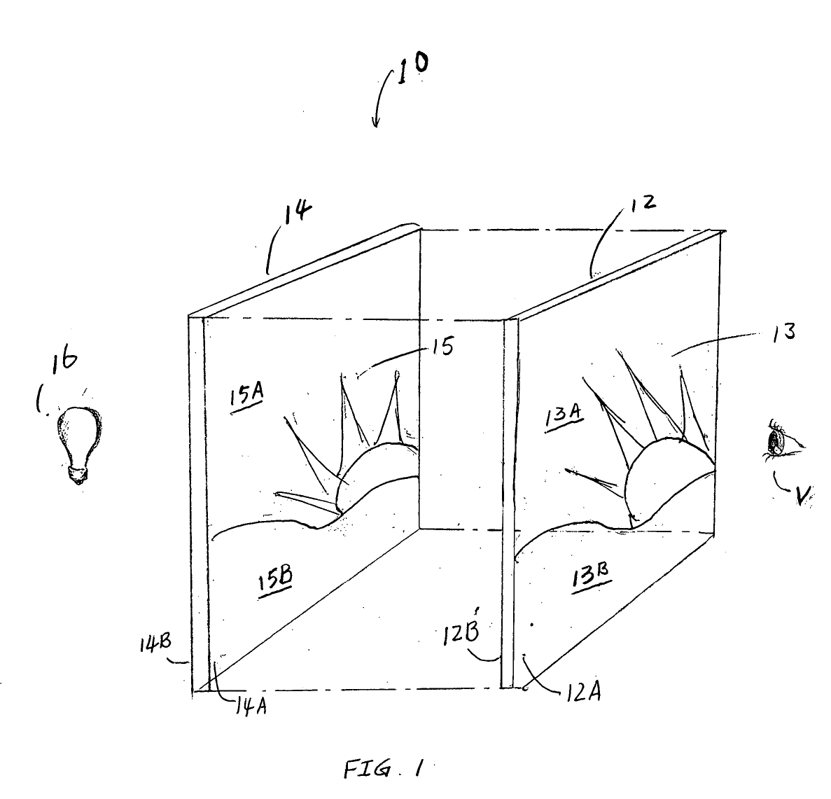

FIG. 1 is an exploded schematic view of image assembly 10 for backlit display in accordance with the present invention. Image assembly 10 includes display medium 12 that bears display image 13, and light masking medium 14 that bears masking image 15. Display medium 12 has front surface 12A facing toward the front side of image assembly 10 and back surface 12B facing toward the back side of image assembly 10. Masking medium 14 has front surface 14A facing toward the front side of image assembly 10 and back surface 14B facing toward the back side of image assembly 10. In a normal operation, light source 16 is placed behind image assembly 10. When lit from the back side, display image 13 is viewable from the front side by the viewer V viewing from the front.

Display image 13 in an ideal or desired viewing status defines a pattern of light density which corresponds to the contrast of the image (display image 13). For convenience, the contrast between two different image regions may be roughly measured by the ratio between the brightness of the regions. The pattern of light density may be given either in great detail to a level of the finest image dots, or in less detail only to a level of larger image areas within the image. The present invention is not restricted to any particular type of method used to describe the pattern of light density of an image. Because the present invention relates to improving a viewing experience, any method used to measure or describe the pattern of light density of a display image must pertain to, and only needs to pertain to, a discernible viewing experience.

In the embodiment shown in FIG. 1, for example, display image 13 roughly contains two regions: region 13A that is relatively bright (corresponding to the portion represents the sky and the sun in the image) and region 13B that is relatively dark (corresponding to the portion that represents the mountain in the image). The relative brightness of the two regions 13A and 13B is a crude definition of the pattern of the light density of display image 13. However, if desirable, a fine pattern of the light density of display image 13 can be described based on brightness of each fine image dot contained in display image 13. The finest image dot is determined by the resolution of the image. For the purpose of the present invention, however, larger image dot areas may be used to define an intermediate-fine pattern of light density.

Masking image 15 on masking medium 14 defines a pattern of light transmittance with respect to the light from light source 16. In the embodiment shown in FIG. 1, masking image 15 is a positive copy of display image 13 with a size ratio of 1:1. The crudest pattern of light transmittance of masking image 15 is defined by the differential light transmittance of two selected areas: 15A that has a relatively high transmittance (corresponding to the portion representing the sky and the sun) and 15B that has a relatively lower transmittance (corresponding to the portion representing two the mountain). That is, the pattern of light transmittance of masking image 15 corresponds to, or is a function of, the pattern of light density of display image 13.

Masking image 15 and display image 13 are so arranged that the pattern of light transmittance of masking image 15 matches the pattern of light density of display image 13. Specifically, with respect to the crudest two-area patterns described above, high transmittance area 15A overlaps with bright area 13A and low transmittance area 15B overlaps with dark area 13B if projected along the viewing direction (roughly defined by a line between and perpendicular to display medium 12 and masking medium 14).

Similar to the pattern of light density described above, the pattern of light transmittance of masking image 15 may be described at any desirable level of resolution. For example, with a low-resolution, masking image 15 may only be a rough sketch of display image 13 to reflect a crude pattern of light transmittance corresponding to a crude in pattern of light density of the display image; with an intermediate resolution, masking image 15 may be an approximate positive copy of display image 13; and with a high resolution, masking image 15 may be a dot-to-dot copy of display image 13.

The above arrangement results in noticeable improvement of the backlit viewing experience of display image 13, most notably a higher image contrast. A lack of contrast is one of the pronounced problems existed in the prior art backlit systems. This problem is different from that of uneven light distribution and hot spots and often has a different cause as well. Even if the light distribution is satisfactorily even and hot spots are largely eliminated, the contrast of the display image may still be unsatisfactory. The contrast of an image relates to ratios of the light density between the brighter areas and the darker areas of the image. An approximate way to measure the contrast of an image is to measure the difference or ratio of the light density between the darkest area and the brightest area of the image. The problem of the loss of contrast of a backlit image is rather unique to the transparent or translucent nature of backlighting as compared to the reflective nature of front lighting. In one scenario, the display medium (e.g., 12 in FIG. 1) bearing the display image (e.g., 13 in FIG. 1) may be entirely transparent. This is the case of a typical transparency film bearing an image. A backlit display using a transparency film usually achieves fairly high contrast. Nevertheless, in cases where the light source is too strong, or the pigment or ink materials that make up the darker areas are too thin (or have a too light density), the darker areas of the image may still be washed out. In another scenario, the display medium may be partially opaque, as in the case of a print or a painting on paper. A backlit display using a partially opaque display medium such as paper may be fairly common due to both the popularity of this type of media and the low cost factor, but there is an inherent loss of contrast due to the nondifferential baseline light blocking caused by the display medium itself.

In both above two different scenarios, the present invention provides an effective way to enhance contrast of the display image by differentially blocking the light before it reaches the display image. Specifically, according to one particular embodiment, the masking image causes less light to reach dark regions while has a relatively little effect on the amount of light that reaches the bright regions of the display image, thus avoids a washout effect of the display image. In the image assembly (e.g., image assembly 10 in FIG. 1) in accordance with the present invention, the masking image (15 in FIG. 1) functions as a light modulator or re-distributor before the light reaches the display image (13). Unlike prior art light modulators or redistributors which are based on structural characteristics unrelated to the display image itself, the pattern of light modulation or redistribution in accordance with the present invention is based on the pattern of light transmittance of masking image 15 which at least partially corresponds to the pattern of light density of display image 13. Accordingly, upon passing masking medium 14 and masking image 15, the light has been at least partially modulated according to the characteristics of display image 13. Specifically, still using the crudest two-area pattern, less amount of light reaches display image area 13B that is supposed to be darker, while relatively more light reaches display image area 13A that is supposed to be brighter. This correlated light modulation enhances, or at least does not reduce, the contrast of display image 13. The present invention thus achieves high specificity of light modulation to improve backlit viewing experience, particularly the contrast of the image.

Although it is possible to purposely reduce the contrast of the display image by using a reverse correlation or negative correlation in which a high transmittance area in the masking image corresponds to a low light density (i.e., darker) area in the display image, and vice versa, in most practical applications a positive correlation is preferred in order to enhance the contrast. This is because most frequently a higher contrast, rather than a lower contrast, is desired.

For better effect, masking medium 14 itself is preferably at least partially transparent to the light from light source, which is usually visible light such as incandescent light or fluorescent light. With masking medium 14 being transparent, the pattern of light transmittance is achieved through the light transmitting characteristics of masking image 15.

Image assembly 10 is made by combining masking medium 14 and display medium 12. Any known method for combining two sheet materials can be used as long as a desired spatial correspondence between the pattern of light transmittance of masking image 15 and the pattern of light density of display image 13 is achieved and maintained in a reliable manner.

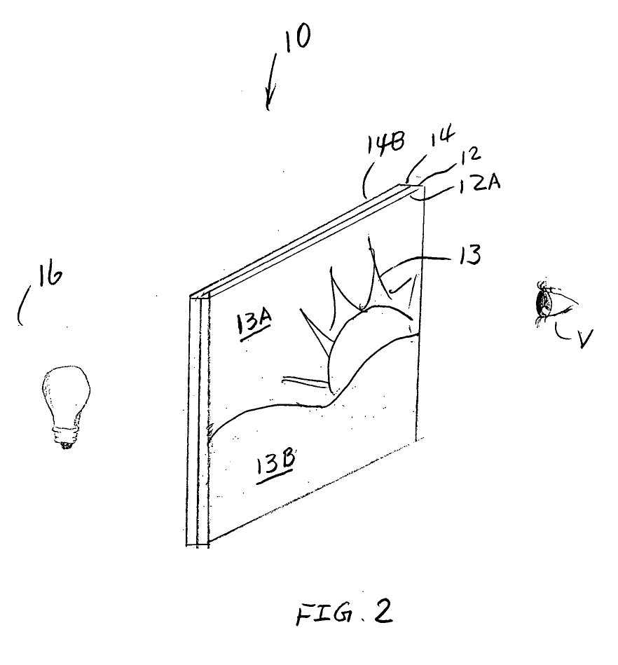

FIG. 2 shows image assembly 10 in a laminated form in which masking medium 14 and display medium 12 are in close contact to each other. Masking medium 14 and masking image 15 thereon form a masking layer, while display medium 12 and display image 13 thereon form a display image layer, two layers being laminated together.

The laminated form shown in FIG. 2 is a convenient way to accomplish such an arrangement in which masking medium 14 is placed immediately behind display medium 12 without any spacing therebetween. Such an arrangement achieves better spatial correspondence between the pattern of light transmittance of masking image 15 and the pattern of light density of display image 13. As shown in FIG. 2, masking medium 14 is coextensive with display medium 12.

Various lamination methods including laminators and lamination by hands can be used. Mechanical means, adhesives, vacuum, or any combination of these, may be used to attach components to each other in the image assembly. In the simplest form, for example, masking medium 14 and display medium 12 may be combined together by using pressure sensitive adhesive tape.

Although illustrated using planar sheets or surfaces, the present invention is by no means limited to such. Instead, the image assembly can be a nonplanar shape such as a rounded or arcuate shape, as long as a proper correspondence between the display image and the masking image is maintained.

Various methods are available for making a masking image on a masking medium. In principle, any known method for creating an image on a substrate (masking medium) that is at least partially transparent may be used, including direct painting, direct drawing, photographic printing, photo filming, and various printing methods known in the art such as lithography and inkjet printing. For example, the masking image can be directly printed on a sheet of paper which functions as a masking medium. In such an embodiment, a certain degree of improvement is achieved as long as the paper used as the masking medium is not completely opaque to the light. Using paper as the masking medium, however, is less preferred for various reasons. First, unless the paper used for printing is highly transparent, light may be unnecessarily blocked across the image by the masking medium (paper) itself regardless of the pattern of light transmittance of the masking image. Second, unevenness of the physical thickness of the paper and light transmittance characteristics across the paper sheet may have a negative effect on the uniformity the display image appearance. For this reason, more transparent materials such as glasses and plastics (e.g., acrylic plastics or Plexiglas) are preferred.

A particularly suitable material for the masking medium is photo film that can be used to produce images in a photo emulsion coated in a plastic substrate, usually a polyethylene terephthalate (PET) film. Accordingly, a preferred method for making a masking image on a masking medium is described as follows.

Instead of using regular printing methods, a highly suitable method for making a masking image on a masking medium in accordance with the present invention is photo filming, a photography process for producing an image on a photo film, particularly a silver halide based film. Using photo film to produce a masking image has at least two advantages. First, the masking image can be created by a familiar photo process based on the display image. Second, photo filming is a direct and simple way to create a masking image that has dot-to-dot registration (correspondence) with the display image. Although as previously discussed, it may be unnecessary to have such dot-to-dot registration because the pattern correspondence on a rougher scale (resolution) may be sufficient in some cases can, it is envisioned that a finer pattern correspondence usually achieves a better result.

By way of illustration, a masking image based on a photo film is created as follows. A photo positive film (e.g., transparency film) is loaded on a suitable camera. A photo picture of the display image is then exposed on the photo transparency film using the camera. Upon photo processing, a properly selected photo positive film produces a positive image of the display image. (In comparison, a photo negative film which would produce a negative image of the display image, the subject of the camera.) Here, the terms “positive” and “negative” are used in their conventional meanings of the photography terminology. The camera is selected based upon the size of the display image. If the exposed and processed photo film is to be used as the masking medium bearing the masking image without further enlargement, the photo film size may be required to be the same size of the display image, or at least the size of a portion of the display image that is desired to be enhanced. Cameras are available for various film sizes. If necessary, special cameras may be used to produce a film of a size of many square feet.

Alternatively, a photo negative film may be used as the masking medium to create a masking image. Because a processed photo negative film bears a negative copy of the display image (the subject of the camera), a second photo negative film can be used to take a picture of the first negative in order to create a positive copy of the display image. This process is more complicated as compared to the previously described method using a photo positive film (e.g., transparency film) but makes available a wider selection of photo films to be used as a masking medium. In addition, the two-step process also introduces an opportunity for further image manipulation, including resizing and enlargement, to produce a desired masking image.

Because the purpose of creating a masking image on a masking medium is to create a pattern of light transmittance correlated to the pattern of light density of the display image, it is unnecessary, although possible, to have a color masking image even though the display image itself may be in color. A black-and-white masking image created based on a black-and-white film is proven to be not only sufficient but also offers the advantage of a straight forward pattern of light transmittance, low-cost and high-efficiency of production as compared to a colored counterpart.

In addition to photo filming, which is most suitable for producing a masking film for an individual customized display image, various printing methods, including electrostatic printing, xeroprinting, thermal printing, transfer printing, silk screen process used for printing artwork may be used. In addition, printing methods used for mass production such as press printing using press plates, whether based on relief printing, lithography or any other principle, may be used to produce both the masking image and the display image itself. Printed media processes that can be applied by a printing press process or screen printing include Baker Perkin printing press, C700 press, C500 press, Heidelberg printing press.

In particular, because typically in press printing an image is separated into four basic process colors, such as cyan, magenta, yellow and black (a negative is created for each color and a photosensitive printing plate is developed for each negative), the process for the black printing of the display image may be readily used to mass produce black-and-white masking images corresponding to the display image.

Making a masking image in accordance with the present invention in its essence involves a step of copying (though not necessarily making an exact copy) certain image attributes of the display image and implement these image attributes into the masking image. The copying may be a positive to negative, a positive to positive, or a positive to negative and then to positive. Depending on the desired result, the copying may be a dot-to-dot copy, or may be a partial or approximate copy. Variety of copying methods may be used to create a masking image as described herein.

Copy elements can be classified as line copy, continuous-tone copy and full-color copy. Each requires its own procedure when being prepared. Line copy has no tonal gradations. It is solid, usually black. The most common example of line copy is type. Other examples of line copy are pen and ink drawings or illustrations. Examples of ink drawings and illustrations include maps, pictures, forms and borders. Spot color, or flat color, is simply line copy printed in a color other than black. Continuous-tone copy has tonal gradations that are tones of light and dark areas rather than one solid color. A black and white photograph is the most common example of continuous-tone copy. Because presses print only solid colors, continuous-tone copy must be converted into dots of varying sizes, which will then appear as varying tones or shades of color. This process (halftoning) can be done with a process camera or electronic scanner producing a film negative or positive.

Three types of film are commonly used in copy reproduction: camera lith film, rapid access film and hybrid (rapid access/lith) film. Line, continuous-tone and full color work require different types of film for quality reproduction. Camera lith film is used to reproduce continuous-tone copy because of its photographic quality. Rapid access film is generally used only for reproducing line copy and not recommended for halftone work. The hybrid (rapid access/lith) film can have the photographic quality of camera lith film and may be used for all three types of copy.

The above description assumes that the display image and the masking image are created on two separate media (display medium and masking medium, respectively). However, it is envisioned the display image and the masking image may be created on a single medium. For example, the display image may be made on the front surface of the display medium while the masking image is made on the back surface of the same display medium. In such an embodiment, a separate masking medium is no longer necessary. The image assembly works much the same way: image specific light modulation is accomplished based on the correlated patterns of light transmittance of the masking image and the light density of the display image. However, in this embodiment using a single medium for both masking image and display image, it may be difficult or even impossible to take advantage of the photo filming method described above to make the masking image.

The display image assembly in accordance with the present invention can be used in various backlit applications, such as a commercial advertisement backlit display units, and backlit arts displays.

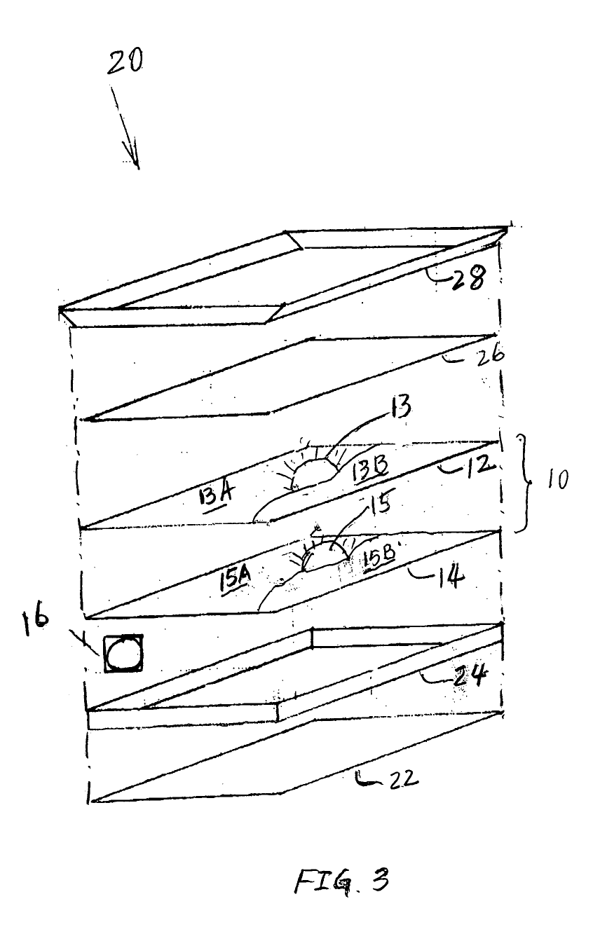

FIG. 3 is an exploded systematic view of a backlit display unit in accordance with the present invention. As shown in FIG. 3, backlit display unit 20 uses backlit display image assembly 10 together with several other peripheral components. Display image assembly 10 includes display image 13 on display medium 12, and masking image 15 on masking medium 14 adjacent to display image 13. Masking image 15 has a pattern of light transmittance which is at least partially determined as a function of the pattern of light density of display image 13, such that the display image has an improved backlit appearance.

Light source 16 is used for illumination from a back side of the display unit. Display image assembly 10 is held with frame assembly 24, backed by backing sheet 22 and covered by glass sheet 26. Backlit display unit 20 further includes external frame 28. Light source 16 may either be a single light source or multiple light sources. Light source 16 is preferably hidden at a side or sides of the frames to reduce hotspots. Light source 16 and the display image assembly 10 can be held in a single display box unit. With the design according to FIG. 3, substantially all the light of the light source can be directed upon masking medium 14 and masking image 15 from the back side.

Other backlit enhancing features such as reflectors, diffusers and light screens known in the prior art may also be used in combination with image assembly 10 in accordance with the present invention. The specific arrangements of these other backlit enhancing features are nonessential to the present invention and are not shown.

Recognizing that a more fundamental modification of the illumination of the picture is possible to improve visibility in low light level situations, this invention provides a novel means to re-distribute image illumination light emanating from one or more light sources. The present invention as implemented in a typical application would include the following items:

(1) A display image, which may be a photograph, a memento, or other translucent object that is the subject matter of the backlit display. Although a landscape picture is shown for purposes of illustration in FIGS. 1 and 2, the present invention should not be construed to require a display image of any particular type or size. The display image is made on a display medium (substrate). The choice of the display medium is determined by the type of the display image and the desired quality and costs. For low to moderate quality backlit display applications, the image medium (substrate) is usually a thin paper stock. The fibrous structure of the paper provides a means to defuse the light, but a thin paper is needed to provide sufficient light transmission. The images is formed on the paper by conventional gravure printing or offset the photographic printing or by other known printing processes. This type of media has the advantages of low-cost and the ability to produce many copies easily, but quality is limited by the nonhomogeneous composition of the paper. The amount of light passing through the paper varies considerably from point to point as a thickness of the paper and the local density of pulp fibrous varies. This limits the quality of the image which can be produced using paper in a backlit display. Paper also has inherent problems of being subject to tearing, yellowing, damage by moisture, dimensional change on different humidity conditions. For high quality images, photo graphic processes can be used to produce images in a photo emulsion coated on a plastic substrate, usually a polyethylene terephthalate (PET) film. Such photo printing process is relatively expensive. Other printing methods, such as inkjet printing may also be used.

(2) A masking image as described herein. The making of the masking image is not limited to any particular method. As far as the method of making is concerned, the masking image may be treated as if it were a conventional display image and made as such, as long as the desired transparency of the substrate (masking medium) bearing the masking image and the desired pattern of light transmittance are achieved. If a photo filming method as described herein is used, the transparency of the substrate is inherent with the film used. If photo graphic printing method or inkjet printing method is used for making the masking image on a PET film, the required transparency can be achieved by coating the transparent PET film substrate with a light diffusing coating, usually a mixture of a resin or gelatin binder and a finely dispersed pigment, such as titanium dioxide. In addition, other materials such as polyester composite films disclosed in U.S. Pat. No. 6,468,641 may also be used for the purpose.

As shown in FIG. 3, an application may include an optional display media container, which may typically comprise a retainer frame to retain the edges of the display media. The display media container may have a wide variety of forms and combinations and still conform to the present invention.

The present invention has a wide variety of applications and embodiments. It may be designed to be front-loaded and to be amenable to wall hanging with no external components other than an optional power cord. Such an application might be a wall of photographs of individuals, company products, a display of art prints, poster, photographs and the like in a residential and office setting.

The present invention improves the utility of the backlit display for the presentation of arts and prints and the like in a home, office or commercial setting through implementation of the aforementioned advantages and may create new customer interest in backlit display systems. When used in combination of other existing methods to improve backlit systems, the invention permits readily available frame styles to be incorporated into the display visual experience, consistent with changing and varied consumer choice stylistic tastes. It also permits a backlit display to be easily integrated in artistic environments such as photographic art gallery prints, poster and the like. More importantly, the present invention permits a highly image-specific and uniquely effective method for modulating the backlit light. Furthermore, allowing making a masking image of high specificity using a photo film, the present invention achieves excellent backlighting illumination for small and medium-sized prints, which may be too small to be backlit by existing lit frame units. Blocking light with a laminated masking film does not increase the overall size of the backlit display unit.

Although the present invention has been described with reference to preferred embodiments, workers skilled in the art will recognize that changes may be made in form and detail without departing from the spirit and scope of the invention.

1. An image assembly for backlit display, comprising:
a display image on a display medium, wherein the display image defines a pattern of light density; and
a masking image disposed at a back side of the display image and adjacent thereto, wherein the masking image has a pattern of light transmittance which is at least partially determined as a function of the pattern of light density of the display image, and the pattern of light transmittance of the masking image and the pattern of the light density of the display image are spatially correlated.

2. The image assembly of claim 1, wherein the masking image is at least an approximate positive copy of the display image.

3. The image assembly of claim 1, wherein the masking image is a positive copy of the display image and has dot-to-dot registration with the display image.

4. The image assembly of claim 1, wherein the masking image is on a masking medium.

5. The image assembly of claim 4, wherein the masking medium is coextensive with the display medium.

6. The image assembly of claim 4, wherein the masking medium is laminated together with the display medium.

7. The image assembly of claim 4, wherein the masking medium is at least partially transparent to visible light.

8. The image assembly of claim 1, wherein the masking image is on the display medium.

9. The image assembly of claim 8, wherein the display image is printed on the front surface of the display medium while the masking image is printed on the back surface of the display medium.

10. A laminate used for backlit display, comprising:
a display image layer having a front surface and a back surface, wherein the display image layer bears a display image, the display image defining a pattern of light density; and
a light masking layer having a front surface and a back surface, wherein the light masking layer and the display image layer are laminated together with the front surface of the light masking layer facing the back surface of the display image layer, and wherein the light masking layer has a pattern of light transmittance, which pattern is at least partially determined as a function of the pattern of light density of the display image.

11. The laminate of claim 10, wherein the pattern of light transmittance of the light masking layer is at least an approximate positive copy of the pattern of light density defined by the display image.

12. The laminate of claim 10, wherein the light masking layer is a photo film.

13. The laminate of claim 10, wherein the light masking layer bears a masking image which is a positive photocopy of the display image.

14. A backlit display unit, comprising:
a light source providing light for illumination from a back side of the display unit;
a display image assembly, comprising:
a display image on a display medium, wherein the display image defines a pattern of light density; and
a masking image disposed at a back side of the display image and adjacent thereto, wherein the masking image has a pattern of light transmittance which is at least partially determined as a function of the pattern of light density of the display image, and the pattern of light transmittance of the masking image and the pattern of the light density of the display image are spatially correlated; and
a frame assembly that holds the image assembly.

15. The backlit display unit of claim 14, wherein the masking image is a positive copy of the display image and has dot-to-dot registration with the display image.

16. The image assembly of claim 14, wherein the masking image is on a masking medium coextensively laminated together with the display medium.

17. The image assembly of claim 16, wherein the masking medium is a photo film.

18. The display unit of claim 14, wherein substantially all the light of the light source is directed upon the display image assembly from the back side thereof.

19. The display unit of claim 14, wherein the light source and the display image assembly are held in a single display box.
